(19) United States
(12) Patent Application Publication
(10) Pub. No.: US 2018/0326641 A1
(43) Pub. Date: Nov. 15, 2018

(54) METHOD FOR MANUFACTURING INFLATABLE MATTRESS AND INFLATABLE MATTRESS

(71) Applicant: SWO-CHUNG CHAI, TAIPEI CITY (TW)

(72) Inventor: SWO-CHUNG CHAI, TAIPEI CITY (TW)

(21) Appl. No.: 16/037,307

(22) Filed: Jul. 17, 2018

Related U.S. Application Data
(63) Continuation-in-part of application No. 15/211,323, filed on Jul. 15, 2016.

(51) Int. Cl. B29C 47/00; A47C 27/08; B29C 65/14; B29C 65/00

(52) U.S. Cl. CPC B29C 47/0064; A47C 27/081; B29C 47/0026; B29K 2075/00; B29C 65/1403; B29C 66/472; B29C 47/0066

(57) ABSTRACT

A method for manufacturing an inflatable mattress includes: Step 1, introducing a plastic material into an extruding machine; Step 2, operating the extruding machine to extrude the plastic material; Step 3, forming a tubular body in the form of a cylinder having a wall having a predetermined thickness; Step 4, cutting the cylindrical tubular body to form seamless tubular strips; and Step 5, connecting two opposite side portions of each of the seamless tubular strips to an upper layer and a lower layer respectively, with the seamless tubular strips being spaced from each other by a predetermined distance. An inflatable mattress so manufactured includes: an upper layer and a lower layer, of which peripheral edges are connected to provide the inflatable mattress with an internal space; and tubular strips arranged in the internal space and having opposite side portions respectively connected to the upper layer and the lower layer.

### REFERENCE TO RELATED APPLICATION

This Application is being filed as a Continuation-in-Part of application Ser. No. 15/211,323, filed 15 Jul. 2016, currently pending.

### FIELD OF THE INVENTION

The present invention relates to a method for manufacturing an inflatable mattress and an inflatable mattress, and more particular to a method for manufacturing an inflatable mattress having a seamless strip and an inflatable mattress having a seamless strip.

### BACKGROUND OF THE INVENTION

Inflatable mattresses are so popular due to their comfortable, soft and warm characteristics. Conventional inflatable mattresses have air bags. Air is pumped into or discharged from the air bags through valves mounted on a lateral side of the inflatable mattresses. When the inflatable mattress is filled with air, the inflatable mattress is inflated and a user can sit on it or lie on it. When air is discharged from the inflatable mattress through the valve, the volume of the inflatable mattress is reduced, and the inflatable mattress is easily to be packed.

Referring to FIG. 1, for the general structure, a conventional inflatable mattress 10 includes an upper layer 11 constituting a surface of the inflatable mattress 10, a lower layer 12 constituting a bottom of the inflatable mattress 10, a lateral layer 13 connecting the upper layer 11 and the lower layer 12 to constitute a periphery of the inflatable mattress 10. The upper layer 11, the lower layer 12 and the lateral layer 13 form an inner space. Several strips 14 are disposed in the inner space and connect the upper layer 11 and the lower layer 12. The strips 14 pull the upper layer 11 and the lower layer 12 and maintain a shape of the inflatable mattress 10 when the inflatable mattress 10 is fully filled with air.

However, the strips 14 are made by welding two polyvinyl chloride (PVC) films through high frequency. As shown in FIG. 2, the conventional strip 14 has fusion traces 141 on two lateral sides which bulge material of the strip 14 and causes a low strength so that the inflatable mattress 10 may readily get broken during inflation, leading to dissatisfactory durability of the inflatable mattress 10.

Thus, it is urgently desired to make improvements for the inflatable mattresses.

### SUMMARY OF THE INVENTION

To achieve the above purposes, the present invention provides a method for manufacturing an inflatable mattress, which comprises, at least, the following steps: Step 1, introducing a plastic material into an extruding machine; Step 2, operating the extruding machine to extrude the plastic material; Step 3, forming a tubular body in the form of a cylinder having a wall having a predetermined thickness; Step 4, cutting the cylindrical tubular body to form seamless tubular strips; and Step 5, connecting two opposite side portions of each of the seamless tubular strips to an upper layer and a lower layer respectively, with the seamless tubular strips being spaced from each other by a predetermined distance.

In the above embodiment, the method further comprises: Step 6A, connecting peripheral edges of the upper layer and the lower layer to form an inflatable mattress having an internal space.

In the above embodiment, the method further comprises: Step 6B, connecting a peripheral edge of the upper layer and a peripheral edge of the lower layer to edges of a lateral layer, respectively, so as to form an inflatable mattress having an internal space.

In the above embodiment, the two side portions of each of the seamless tubular strips are connected to the upper layer and the lower layer through radio frequency welding.

In the above embodiment, the predetermined thickness of the wall is 0.10 mm˜1.00 mm.

The present invention also provides an inflatable mattress, which comprises: an upper layer, which forms a surface of the inflatable mattress; a lower layer, which forms a bottom of the inflatable mattress and is connected to a peripheral edge of the upper layer such that the inflatable mattress is formed with an internal space; and at least one tubular strip, which is arranged in the internal space, the tubular strip having two opposite side portions that are connected to the upper layer and the lower layer, respectively, the at least one tubular strip comprising at least two strips that are spaced from each other by a predetermined distance; wherein the at least one tubular strip is integrally formed and has no jointing seam.

In the above embodiment, the tubular strip is made of thermoplastic polyurethane (TPU).

In the above embodiment, the tubular strip is made of polyvinyl chloride (PVC).

In the above embodiment, the tubular strip has a wall having a thickness of 0.10 mm˜1.00 mm.

The present invention further provides an inflatable mattress, which comprises: an upper layer, which forms a surface of the inflatable mattress; a lower layer, which forms a bottom of the inflatable mattress; a lateral layer, which is connected to peripheral edges of the upper layer and the lower layer to form a lateral side of the inflatable mattress, the upper layer, the lower layer, and the lateral layer collectively delimit and define an internal space of the inflatable mattress; and at least one tubular strip, which is arranged in the internal space, the tubular strip having two opposite side portions that are connected to the upper layer and the lower layer, respectively, the at least one tubular strip comprising at least two strips that are spaced from each other by a predetermined distance; wherein the at least one tubular strip is integrally formed and has no jointing seam.

In the above embodiment, the tubular strip is made of thermoplastic polyurethane (TPU).

In the above embodiment, the tubular strip is made of polyvinyl chloride (PVC).

In the above embodiment, the tubular strip has a wall having a thickness of 0.10 mm˜1.00 mm.

The present invention provides a method for manufacturing an inflatable mattress and an inflatable mattress. The inflatable mattress uses seamless tubular strips. The tubular strips are formed by extruding a plastic material through an extruding machine to provide a cylindrical tubular body having a relatively thin wall and subjecting the cylindrical tubular body to cutting and are thus each formed integrally as a unitary structure having no jointing seam to thereby greatly improve the strength of the strips and making the strip more resistant to breaking. Thus, the inflatable mattress that uses the tubular strips is also improved in respect of durability thereof.

### BRIEF DESCRIPTION OF THE DRAWINGS

FIG. 1 is a schematic view illustrating an inflatable mattress in which conventional strips are involved;

FIG. 2 is a schematic view illustrating the conventional strip;

FIG. 3A is a flow chart illustrating a method for manufacturing an inflatable mattress according to an embodiment of the present invention;

FIG. 3B is a flow chart illustrating a method for manufacturing an inflatable mattress according to an embodiment of the present invention;

FIG. 4 is a schematic view illustrating a cylindrical tubular body formed with the present invention;

FIG. 5 is a schematic view illustrating a tubular strip according to the present invention;

FIG. 6A is a schematic view illustrating an inflatable mattress according to an embodiment of the present invention;

FIG. 6B is a schematic view illustrating an inflatable mattress according to an embodiment of the present invention;

FIGS. 7A-7C are schematic views illustrating variation of a shape of the tubular strip during an inflation process of the inflatable mattress; and

FIG. 8 is a schematic view illustrating forces acting on the inflatable mattress according to the present invention.

### DETAILED DESCRIPTION OF THE PREFERRED EMBODIMENTS

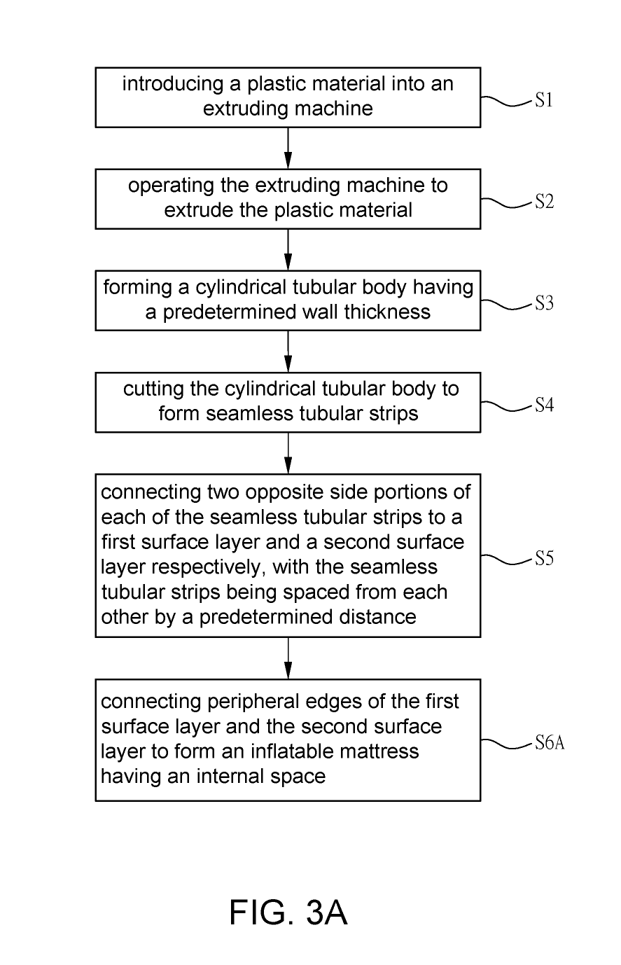

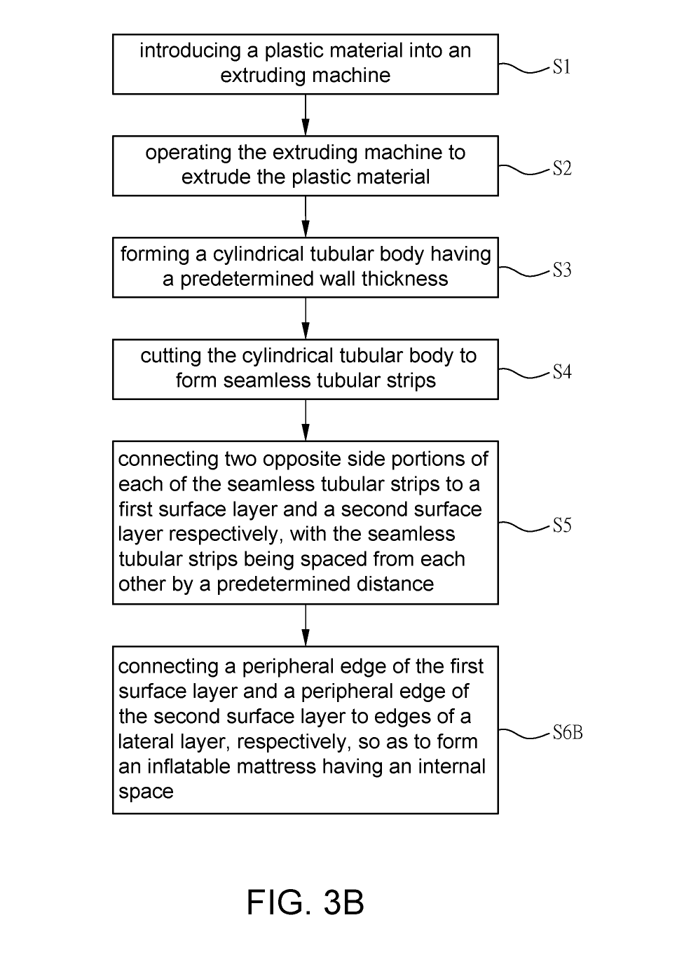

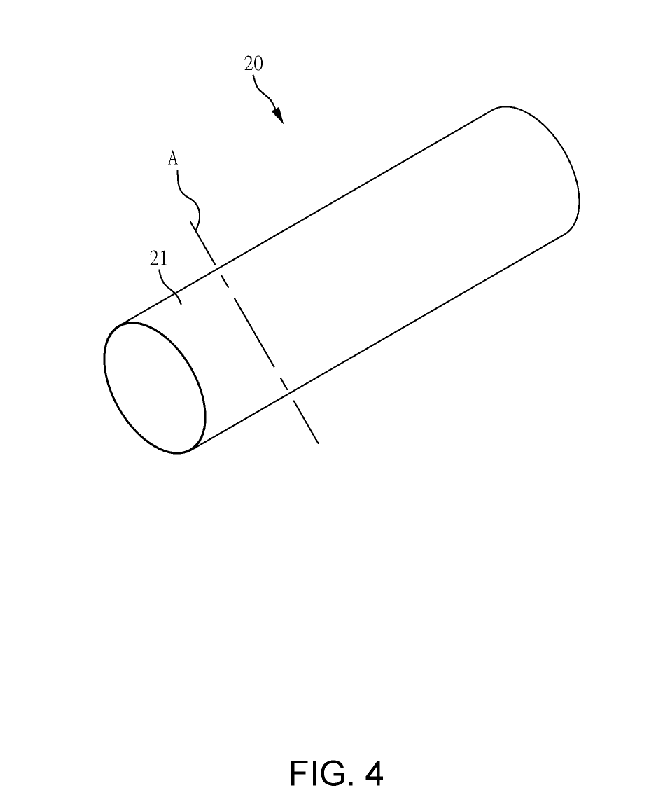

Referring collectively to FIGS. 3A to 6B, the present invention provides a method for manufacturing an inflatable mattress, comprising, at least, the following steps: Step 1 (S1), introducing a plastic material into an extruding machine; Step 2 (S2), extruding the plastic material with the extruding machine; Step 3 (S3), forming a tubular body 20 in the form of a cylindrical shape having a wall of a predetermined thickness; Step 4 (S4), cutting the cylindrical tubular body 20 along cutting lines A (only one cutting line being visible in the drawings) to form seamless tubular strips 21; and Step 5 (S5), connecting opposite side portions of each of the seamless tubular strips 21 to an upper layer 11 and a lower layer 12, respectively, such that the seamless tubular strips 21 are spaced from each other by a predetermined distance.

In one embodiment, the method for manufacturing an inflatable mattress further comprises Step 6A (S6A), connecting peripheral edges of the upper layer 11 and the lower layer 12 to each other to form an inflatable mattress 100a having an internal space S.

Optionally, in another embodiment, the method for manufacturing an inflatable mattress further comprises Step 6B (S6B), connecting peripheral edges of the upper layer 11 and the lower layer 12 to edges of a lateral layer 13 so as to form an inflatable mattress 100b having an internal space S.

The plastic material introduced into the extruding machine in Step 1 (S1) is thermoplastic polyurethane (TPU) or polyvinyl chloride (PVC).

Preferably, the cylindrical tubular body 20 formed in Step 3 (S3) has a wall having a thickness of 0.10 mm˜1.00 mm.

In Step 5 (S5), the two opposite portions of each of the seamless tubular strips 21 are connected to the upper layer 11 and the lower layer 12 through radio frequency welding.

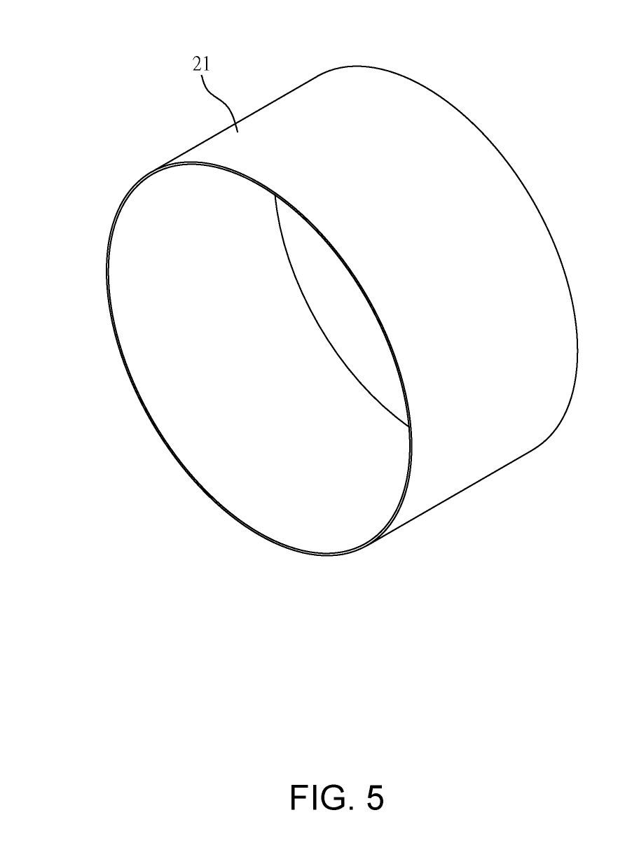

As shown in FIG. 5, the cylindrical tubular body 20, after subjected to cutting carried out in Step 4 (S4), forms one or more seamless tubular strips 21.

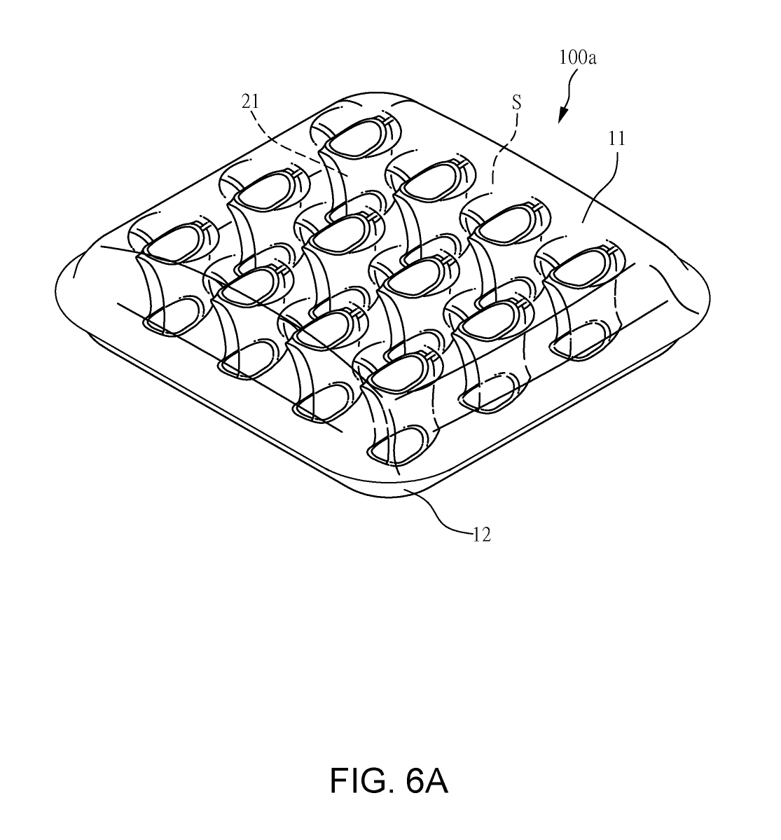

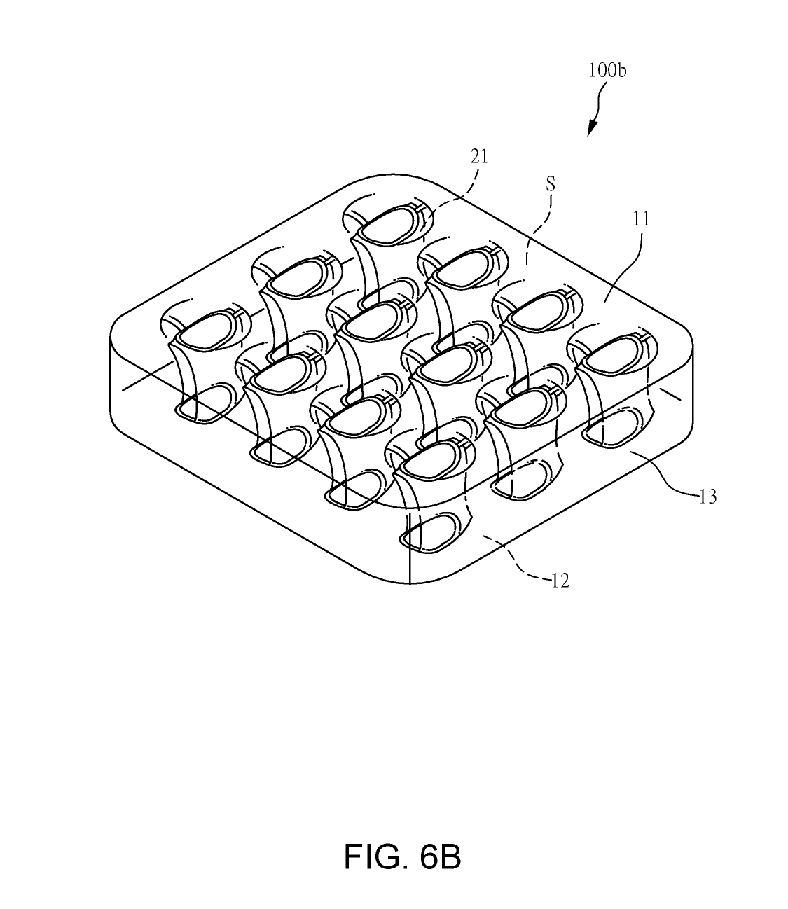

After Step 5 (S5) and Step 6A (S6A) or Step 6B (S6B), an inflatable mattress 100a (as shown in FIG. 6A) or an inflatable mattress 100b (as shown in FIG. 6B) is formed.

The present invention also provides an inflatable mattress 100a, as shown in FIG. 6A, which is manufactured with one of the above-descried embodiments of the method for manufacturing an inflatable mattress. The inflatable mattress 100 so manufactured comprises: an upper layer 11, a lower layer 12, and at least a tubular strip 21.

The upper layer 11 forms a surface of the inflatable mattress 100 and the lower layer 12 forms a bottom of the inflatable mattress 100. The lower layer 12 and the upper layer 11 are connected to each other along peripheral edges thereof so as to provide the inflatable mattress with an internal space S.

The tubular strips 21 are arranged in the internal space S, such that the tubular strips 21 are each connected, with two opposite side portions thereof, to the upper layer 11 and the lower layer 12, respectively, and strips are spaced from each other by a predetermined distance, wherein each of the tubular strips 21 is formed integrally as a unitary structure and has no jointing seam.

In the instant embodiment, the tubular strips 21 are each manufactured with Steps 1-4 (S1-S4) described above.

In some preferred embodiments, the tubular strips 21 each have a wall having a thickness of 0.10 mm˜1.00 mm.

In some preferred embodiments, the tubular strips 21 are made of a material that is polyvinyl chloride (PVC) or thermoplastic polyurethane (TPU).

Referring to FIG. 6B, another example of an inflatable mattress 100b is shown, which is manufactured with the other one of the above-described embodiments of the method for manufacturing an inflatable mattress. The inflatable mattress 100b comprises an upper layer 11, a lower layer 12, a lateral layer 13, and at least one tubular strip 21.

The lateral layer 13 is connected, with edges thereof, to peripheral edges of the upper layer 11 and the lower layer 12 to form a lateral side of the inflatable mattress 100b. The lateral layer 13, the upper layer 11, and the lower layer 12 collectively delimit and define an internal space S of the inflatable mattress.

The tubular strips 21 are arranged in the internal space S and the tubular strips 21 are each connected, with two opposite side portions thereof, to the upper layer 11 and the lower layer 12. The tubular strips 21 are spaced from each other by a predetermined distance.

In the instant embodiment, the tubular strips 21 are each manufactured with Steps 1-4 (S1-S4) described above.

In a preferred embodiment, the tubular strips 21 each have a wall having a thickness of 0.10 mm˜1.00 mm.

In some preferred embodiments, the tubular strips 21 are made of a material that is polyvinyl chloride (PVC) or thermoplastic polyurethane (TPU).

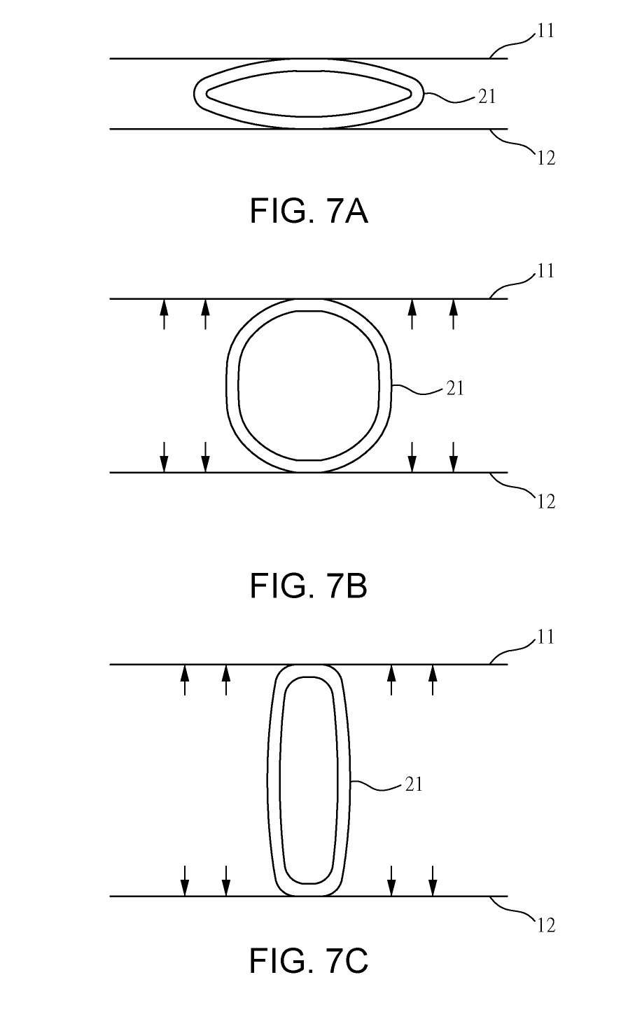

Next, referring to FIGS. 7A-7C, functionality and operation of the seamless tubular strips 21 that are arranged in the inflatable mattress 100a or the inflatable mattress 100b will be described.

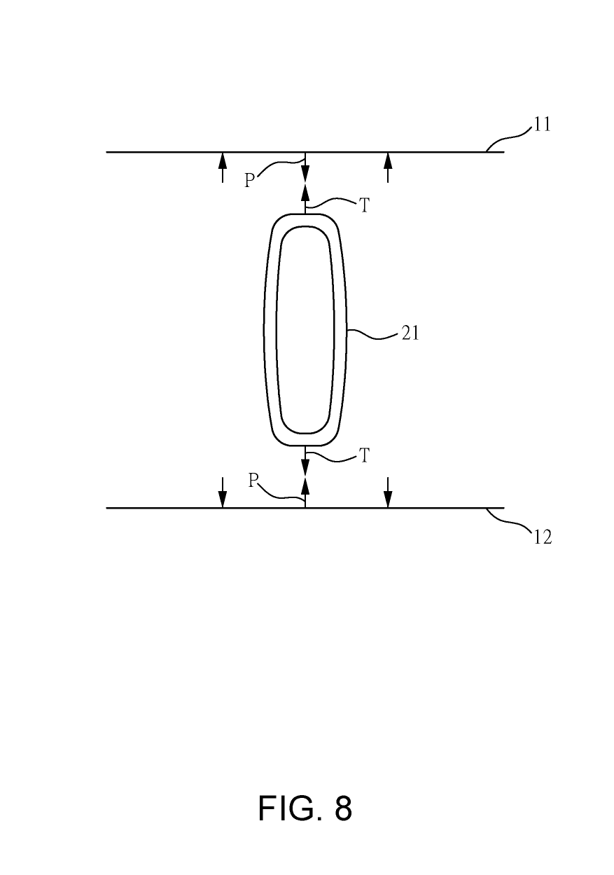

At the beginning, before the inflatable mattress 100a or the inflatable mattress 100b is not yet inflated, as shown in FIG. 7A, the seamless tubular strips 21 are partially collapsed due to their own weights to show a partly flattened configuration. Under such a condition, the upper layer 11 and the lower layer 12 of the inflatable mattress 100a or the inflatable mattress 100b are close to each other with a short distance therebetween. And, then, when the inflatable mattress 100a or the inflatable mattress 100b is being inflated, as shown in FIG. 7B, due to air or gas introduced, the upper layer 11 and the lower layer 12 of the inflatable mattress 100a or the inflatable mattress 100b start to move away from and thus separate from each other (in which the moving direction is indicted by arrows in the drawings) and pull and stretch the tubular strips 21. Finally, as shown in FIG. 7C, and also FIG. 8, when the inflatable mattress 100a or the inflatable mattress 100b has been inflated to such an extent that the tubular strips 21 are pulled and stretched to show a vertically straightened configuration, the tubular strips 21 are each acted upon by a tension force T. FIG. 8 provides a free body diagram of the tubular strip 21 as being acted upon by the force, a reaction force P caused by the tension force T pulls and holds the upper layer 11 and the lower layer 12 together so that the spacing distance between the upper layer 11 and the lower layer 12 is kept within a desired range. Thus, as being acted upon and restrained by multiple tubular strips 21, the inflatable mattress 100a or the inflatable mattress 100b does not get bulged to show a spherical or virtually sphere configuration due to inflation.

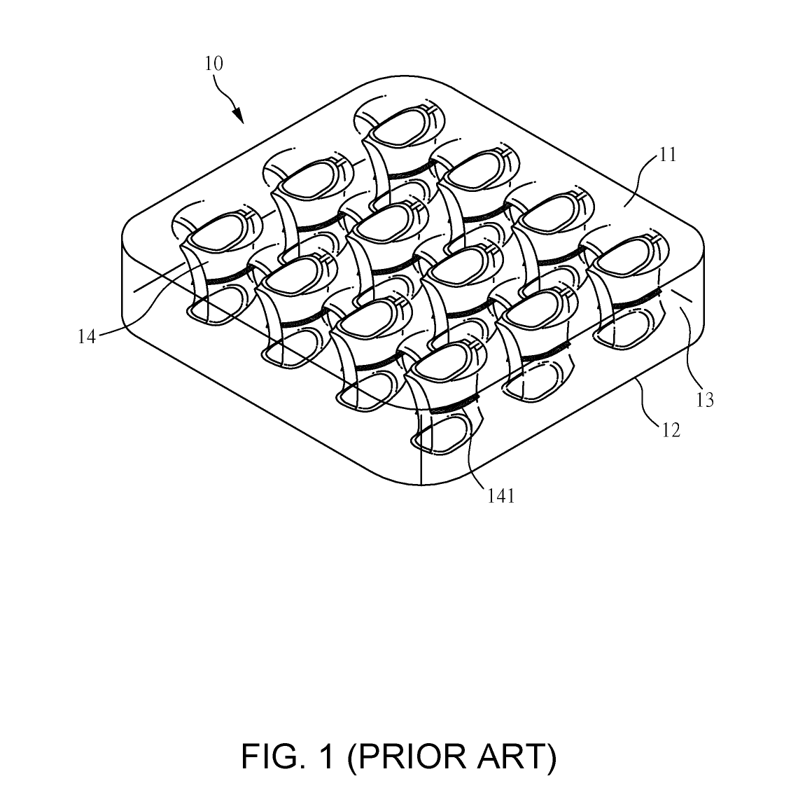

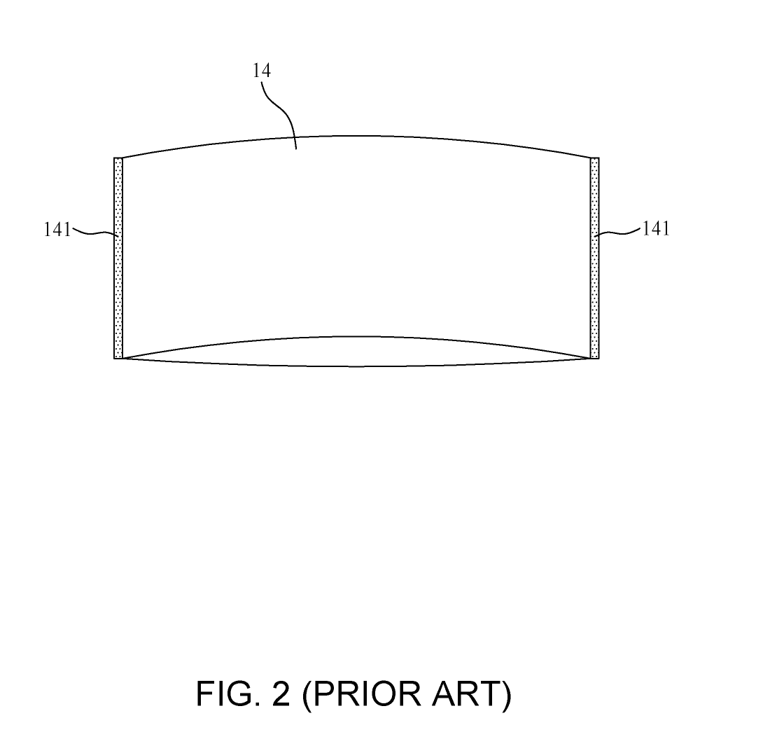

In the inflatable mattress 100a or the inflatable mattress 100b according to the present invention, the tubular strip 21 is integrally formed and has no jointing seam so that it is possible to overcome the drawbacks of the conventional strips 14 shown in FIGS. 1 and 2. As shown in FIGS. 1 and 2, the conventional strip 14 is formed by fusing or welding two PVC films, such that during an inflation process of the inflatable mattress 10 (similar to an inflation process illustrated in FIGS. 7A-7C), the strip 14 would readily get broken along the welding lines 141 of the two opposite side edges. The tubular strip 21 of the inflatable mattress 100a or the inflatable mattress 100b of the present invention, on the contrary, includes no welding line and thus no jointing seam so as to provide improved strength to resist tension caused by inflation to thereby avoid undesired breaking.

In summary, the present invention provides a method for manufacturing an inflatable mattress and an inflatable mattress so manufactured, in which a plastic material is extruded with an extruding machine to form a tubular body in the form of a cylinder having a relatively thin wall. Such a cylindrical tubular body is then cut into one or multiple seamless tubular strips, which can be used as pull strips inside an inflatable mattress. The seamless tubular strips have a strength that is much higher as compared to the conventional strips and is more resistant to breaking so that an inflatable mattress fabricated with such strips would be more durable and not easy to break.

What is claimed is:

1. A method for manufacturing an inflatable mattress, comprising the following steps:
Step 1, introducing a plastic material into an extruding machine;
Step 2, operating the extruding machine to extrude the plastic material;
Step 3, forming a tubular body in the form of a cylinder having a wall having a predetermined thickness;
Step 4, cutting the cylindrical tubular body to form seamless tubular strips; and
Step 5, connecting two opposite side portions of each of the seamless tubular strips to an upper layer and a lower layer respectively, with the seamless tubular strips being spaced from each other by a predetermined distance.

2. The method for manufacturing an inflatable mattress according to claim 1 further comprising Step 6A, connecting peripheral edges of the upper layer and the lower layer to form an inflatable mattress having an internal space.

3. The method for manufacturing an inflatable mattress according to claim 1 further comprising Step 6B, connecting a peripheral edge of the upper layer and a peripheral edge of the lower layer to edges of a lateral layer, respectively, so as to form an inflatable mattress having an internal space.

4. The method for manufacturing an inflatable mattress according to claim 1, wherein the two side portions of each of the seamless tubular strips are connected to the upper layer and the lower layer through radio frequency welding.

5. The method for manufacturing an inflatable mattress according to claim 1, wherein the predetermined thickness of the wall is 0.10 mm˜1.00 mm.

6. An inflatable mattress, comprising:
an upper layer, which forms a surface of the inflatable mattress;
a lower layer, which forms a bottom of the inflatable mattress and is connected to a peripheral edge of the upper layer such that the inflatable mattress is formed with an internal space; and
at least one tubular strip, which is arranged in the internal space, the tubular strip having two opposite side portions that are connected to the upper layer and the lower layer, respectively, the at least one tubular strip comprising at least two strips that are spaced from each other by a predetermined distance;
wherein the at least one tubular strip is integrally formed and has no jointing seam.

7. The inflatable mattress according to claim 6, wherein the tubular strip is made of thermoplastic polyurethane (TPU).

8. The inflatable mattress according to claim 6, wherein the tubular strip is made of polyvinyl chloride (PVC).

9. The inflatable mattress according to claim 6, wherein the tubular strip has a wall having a thickness of 0.10 mm˜1.00 mm.

10. An inflatable mattress, comprising:
an upper layer, which forms a surface of the inflatable mattress;
a lower layer, which forms a bottom of the inflatable mattress;
a lateral layer, which is connected to peripheral edges of the upper layer and the lower layer to form a lateral side of the inflatable mattress, the upper layer, the lower layer, and the lateral layer collectively delimit and define an internal space of the inflatable mattress; and
at least one tubular strip, which is arranged in the internal space, the tubular strip having two opposite side portions that are connected to the upper layer and the lower layer, respectively, the at least one tubular strip comprising at least two strips that are spaced from each other by a predetermined distance;
wherein the at least one tubular strip is integrally formed and has no jointing seam.

11. The inflatable mattress according to claim 10, wherein the tubular strip is made of thermoplastic polyurethane (TPU).

12. The inflatable mattress according to claim 10, wherein the tubular strip is made of polyvinyl chloride (PVC).

13. The inflatable mattress according to claim 10, wherein the tubular strip has a wall having a thickness of 0.10 mm˜1.00 mm.
